(19) United States
(12) Patent Application Publication
(10) Pub. No.: US 2023/0166449 A1
(43) Pub. Date: Jun. 1, 2023

(54) 3D PRINTER

(71) Applicant: Shanghai Yannuo Building Material Co., Ltd., Shanghai (CN)

(72) Inventor: Yihe MA, Shanghai (CN)

(21) Appl. No.: 17/540,034

(22) Filed: Dec. 1, 2021

(51) Int. Cl. B29C 64/232; B29C 64/245; B29C 64/236; B33Y 30/00

(52) U.S. Cl. CPC B29C 64/232; B29C 64/245; B29C 64/236; B33Y 30/00

(57) ABSTRACT

A 3D printer including a support structure, a lifting mechanism, an adjusting mechanism, a moving mechanism and a printing component. The 3D printer is specifically suitable for 3D printing of buildings or other structures in the field of construction. The adjusting mechanism and the lifting mechanism are arranged below the support structure. The lifting mechanism moves the support structure up and down in the vertical direction. The adjusting mechanism moves the support structure in the horizontal direction. The printing component is arranged on the moving mechanism. The moving mechanism is arranged on the support structure in such fashion that it is movable up and down in the vertical direction.

### FIELD OF THE INVENTION

The present invention relates to the technical field of 3D printing, in particular to a 3D printer.

### BACKGROUND OF THE INVENTION

3D printers are becoming more and more common in our life and widely used in various fields. A more recent development in 3D printing is creating buildings or other structures by 3D printing in the field of construction. When printing a model, the deviation due to position movement often leads to the deviation of the printed tooling structure from the actual requirements, which further affects the quality of the printed model.

### SUMMARY OF THE INVENTION

According to an aspect of the invention, a 3D printer is created, comprising: a support structure, a lifting mechanism, an adjusting mechanism, a moving mechanism and a printing component; wherein the adjusting mechanism and the lifting mechanism are arranged below the support structure; the lifting mechanism is adapted to move the support structure up and down in the vertical direction; the adjusting mechanism is adapted to move the support structure in the horizontal direction; the printing component is arranged on the moving mechanism, and the moving mechanism is arranged on the support structure in such fashion that it is movable up and down in the vertical direction.

### DETAILED DESCRIPTION OF THE INVENTION

The present application provides a 3D printer. On one hand, the height of the printing component can be adjusted vertically by the moving mechanism, and at the same time, the height of the initial position of the printing component can be adjusted by the lifting mechanism, and the adjusting mechanism can also adjust the horizontal position of the printing component, thereby reducing the deviation between the model printed by the printing component and the actual model and improving the printing quality.

In order to achieve the above object, the present application provides a 3D printer, including a support structure, a lifting mechanism, an adjusting mechanism, a moving mechanism and a printing component. The adjusting mechanism and the lifting mechanism are arranged below the support structure successively, wherein the lifting mechanism is used for reciprocating the support structure in the vertical direction, and the adjusting mechanism is used for moving the support structure in the horizontal direction. The printing component is arranged on the moving mechanism, and the moving mechanism is arranged on the support structure and can move along the vertical direction.

In the 3D printer of the present invention, the initial position of the printing component in the vertical direction can be adjusted by the lifting mechanism arranged below the support structure at the beginning, and an adjusting mechanism is also arranged below the lifting mechanism and the support structure, which can adjust the position of the printing component in the horizontal direction. At the same time, in the printing process, the position of the printing component has been adjusted to the best positioning, and the moving mechanism drives the printing component to move in the vertical direction to complete printing. In this embodiment, due to the adjustment of the adjusting mechanism and the lifting mechanism, the deviation of the model printed by the printing component from the actual model can be reduced, and the printing quality can be improved.

Preferably, the lifting mechanism comprises a plurality of lifting mechanisms.

Preferably, the lifting mechanism comprises a base, a screw, a worm gear mechanism, a first drive motor and a first mounting plate for mounting the first drive motor.

The screw is fixedly arranged with its one end on the base and the other end of the screw is connected to the adjusting mechanism. The first mounting plate is installed on the worm gear mechanism, the worm wheel in the worm gear mechanism is installed on the screw, and the worm screw is connected with the output shaft of the first drive motor.

Preferably, the lifting mechanism further comprises a handwheel, and the handwheel is connected with its one end of the worm screw that is spaced apart from the first drive motor.

Preferably, the adjusting mechanism comprises a plurality of adjusting mechanisms, and a plurality of the adjusting mechanisms and a plurality of the lifting mechanisms are arranged in one-to-one correspondence.

Preferably, the adjusting mechanism includes a second drive motor, a second mounting plate, a connecting plate, a slot seat and a moving plate. In this embodiment, the connecting plate is arranged at the end close to the lifting mechanism, the slot seat is fixed at one end of the connecting plate that is spaced apart from the lifting mechanism. The moving plate is installed on the slot seat and can slide relative to the slot seat. The moving plate is internally provided with a screw nut and a passage for the worm screw to pass through, and the output end of the second drive motor is connected with the worm screw to drive the moving plate to slide along the extension direction of the slot seat. The second mounting plate is fixed on the connecting plate for mounting the second drive motor, and one end of the moving plate that is spaced apart from the slot seat is connected with the support structure.

Preferably, the support structure includes a horizontal bracket and a vertical bracket, the adjusting mechanism and the lifting mechanism are installed successively below the horizontal bracket, and the moving mechanism is installed on the vertical bracket.

The vertical bracket is vertically arranged on the horizontal bracket.

Preferably, the moving mechanism comprises a third drive motor, a connecting structure, a guide rail, a slider and a rack. The rack and the guide rail are both arranged on the vertical bracket, and the guide rail is arranged in parallel with the rack. The slider and the third drive motor are both installed on the connecting structure. The slider meshes with the guide rail, and the output shaft of the third drive motor is provided with a gear for matching with the rack.

Preferably, the printing component comprises a first bell-mouth mold, a second bell-mouth mold, a fourth drive motor, a first rotating member and a second rotating member. The first bell-mouth mold is installed on the first rotating member, the second bell-mouth mold is installed on the second rotating member, the first rotating member, the second rotating member and the fourth drive motor are all installed on the connecting structure, and the fourth drive motor is used to drive the first rotating member and the second rotating member to rotate to control the opening and closing of the first bell-mouth mold and the second bell-mouth mold.

Preferably, the first rotating member comprises a first rotating plate, a first rotating shaft and a first gear wheel. The first rotating plate is rotatably mounted on the connecting structure through the first rotating shaft, and the first gear wheel is mounted on the first rotating shaft.

The second rotating member comprises a second rotating plate, a second rotating shaft and a second gear wheel, with the second rotating plate being rotatably installed on the connecting structure through the second rotating shaft. The second gear wheel is installed on the second rotating shaft, the first gear wheel is in transmission connection with the second gear wheel, and the first gear wheel is connected with the pinion installed on the fourth drive motor.

### BRIEF DESCRIPTION OF THE DRAWINGS

FIG. 1 is the first perspective view of the 3D printer according to the embodiment of the present application.

FIG. 2 is the second perspective view of the 3D printer according to the embodiment of the present application.

FIG. 3 is a schematic perspective view of a lifting mechanism of the 3D printer according to an embodiment of the present application.

FIG. 4 is a schematic side view of a lifting mechanism and an adjusting mechanism of the 3D printer according to an embodiment of the present application.

FIG. 5 is a schematic perspective view of the 3D printer adjusting mechanism according to an embodiment of the present application.

FIG. 6 is a schematic perspective view of a moving mechanism and a printing component of the 3D printer according to an embodiment of the present application.

### DETAILED DESCRIPTION OF THE DRAWINGS

In order to make the purpose of the invention clearer, including the technical effects and advantages of the embodiments disclosed in the present invention, the technical effects thereof will be clearly and completely described below with reference to the drawings therein. Obviously, the embodiments described are part of the present invention embodiments other than all. Generally, the components of the embodiments disclosed in the present invention described herein and shown in the drawings can be arranged and designed in various different configurations.

Therefore, the following detailed description of the embodiments of the present invention provided in the drawings is not intended to limit the scope of the claimed invention, but only represents selected embodiments of the present invention. Based on the embodiments of the present invention, all other embodiments obtained by those skilled in the art without creative work are within the scope of protection of the present invention.

It should be noted that: Similar reference numerals and letters indicate similar items in the following drawings, so once an item is defined in one drawing, it does not need to be further defined and explained in the following drawings.

In the description of the embodiments of the present invention, it should be noted that the orientation or positional relationship indicated by the terms “center”, “upper”, “lower”, “left”, “right”, “vertical”, “horizontal”, “inside” and “outside” is based on what is shown in the drawings, or on what would typically be implemented in a product according to the present invention Such terms are only used for description and simplified description of the present invention other than to indicate or imply that the devices or components involved must be constructed and operated in such specific orientations, and therefore, cannot be understood as the limitations for the present invention. In addition, the terms “first”, “second” and “third” are only used for distinction in the description, and cannot be understood as indicating or implying relative importance.

In addition, the terms “horizontal”, “vertical” and “overhanging” do not mean that the components are absolutely horizontal or overhanging, but can be slightly inclined. For example, “horizontal” only means that its direction is more horizontal than “vertical”, which does not mean that the structure must be completely horizontal, and it can be slightly tilted.

In the description of the embodiments of the present invention, it should be noted that the terms “setting”, “installing”, “associating” and “connecting” should be understood in a broad sense. For example, they can be fixed connection, detachable connection or integrated connection, mechanical connection, or electric connection, direct connection or connection via an intermediate medium or internal communication of two elements. For those skilled in the art, the specific meanings of the above terms in the embodiments of the present invention can be understood according to specific circumstances.

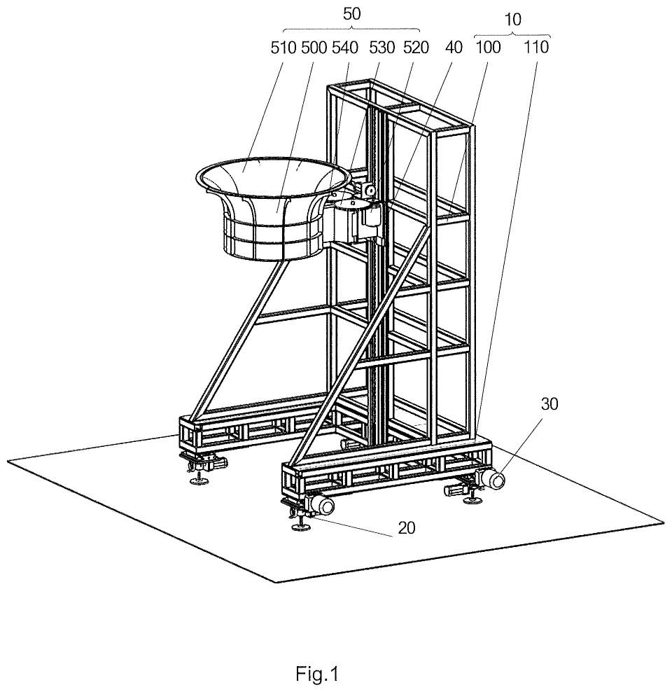

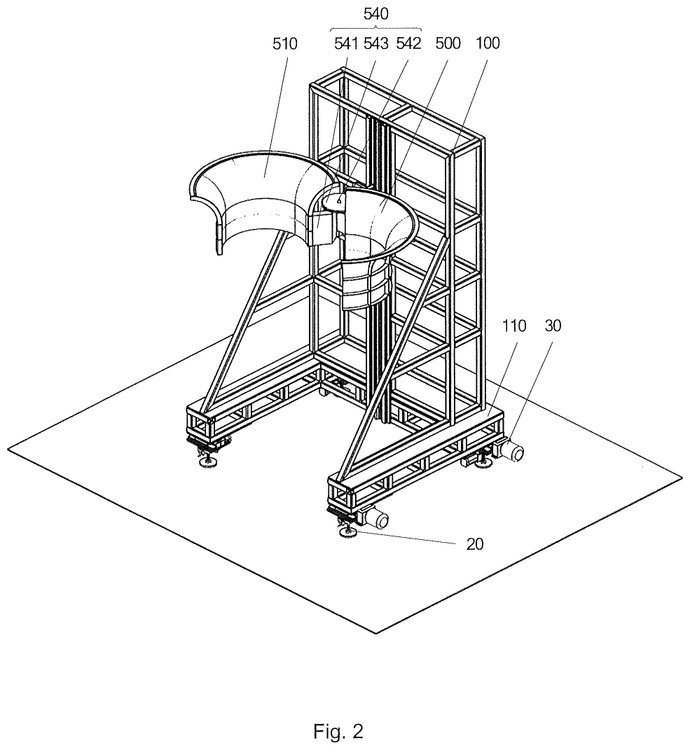

FIG. 1 is a first perspective view of the 3D printer according to an embodiment of the present application and FIG. 2 is a second perspective view of the 3D printer according to an embodiment of the present application. Referring to FIG. 1 and FIG. 2, the embodiment of the present invention provides a 3D printer, which comprises a support structure 10, a lifting mechanism 20, an adjusting mechanism 30, a moving mechanism 40 and a printing component 50.

The adjusting mechanism 30 and the lifting mechanism 20 are arranged below the support structure 10 successively, the lifting mechanism 20 is used to move the support structure 10 up and down in the vertical direction, and the adjusting mechanism 30 is used to make the support structure 10 move in the horizontal direction.

The printing component 50 is arranged on the moving mechanism 40, and the moving mechanism 40 is arranged on the support structure 10 and can move in the vertical direction.

In the 3D printer of the present application, the initial position of the printing component 50 in the vertical direction can be adjusted by the lifting mechanism 20 arranged below the support structure 10 at the beginning. The adjusting mechanism 30 is also arranged below the lifting mechanism 20 and the support structure 10. The adjusting mechanism 30 can adjust the position of the printing component 50 in the horizontal direction, and at the same time, the position of the printing component 50 has been adjusted to the best in the printing process. The moving mechanism 40 drives the printing component 50 to move in the vertical direction to complete printing. The deviation of the model printed by the printing component 50 from the actual model can be reduced and the printing quality can be improved because of the adjustment of the adjusting mechanism 30 and the lifting mechanism 20.

Alternatively, the lifting mechanism 20 includes a plurality of lifting mechanisms. The plurality of lifting mechanisms can work synchronously to ensure that all parts of the printing component 50 remain in the same plane when moving in the vertical direction. In addition, the lifting mechanism can take many forms, such as telescopic rod, cylinder, hydraulic device, etc.

It should be noted that the number of the lifting mechanisms can be three, four or five, as long as all parts of the support structure 10 can be lifted synchronously.

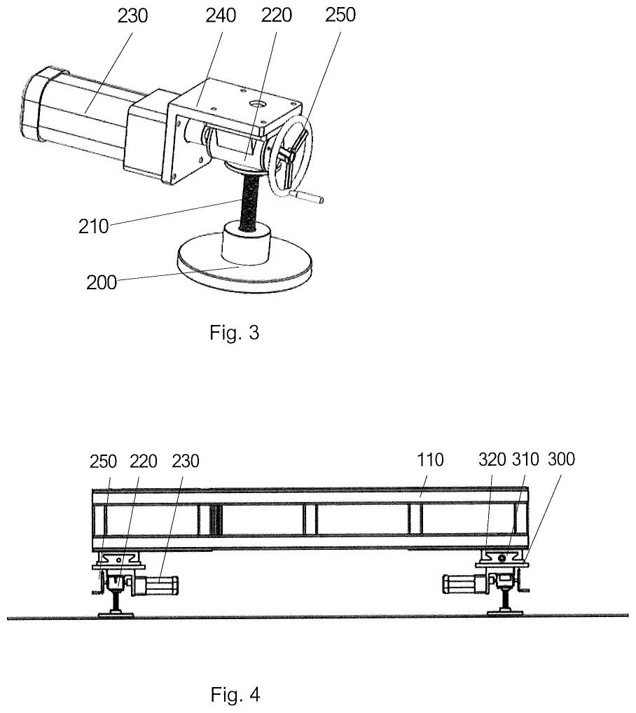

FIG. 3 is a schematic perspective view of a lifting mechanism 20 of the 3D printer according to an embodiment of the present application. As shown in FIG. 3, as an alternative, the lifting mechanism includes a base 200, a screw 210, a worm gear mechanism 220, a first drive motor 230 and a first mounting plate 240 to which the first drive motor 230 is attached. The screw 210 is fixedly arranged on the base 200, the other end of the screw 210 is connected to the adjusting mechanism 30, the first mounting plate 240 is installed on the worm gear mechanism 220, the worm wheel in the worm gear mechanism 220 is installed on the screw 210, and the worm screw is connected with the output shaft of the first drive motor 230.

In this embodiment, when driving the support structure 10 to move in the vertical direction, the first drive motor 230 is attached to the first mounting plate 240, and the output shaft of the first drive motor 230 is connected with the worm screw in the worm gear mechanism 220 through a coupling. As the worm wheel in the worm gear mechanism 220 is connected with the screw 210, the inner wall of the worm wheel needs to be provided with threads which are in threaded engagement with the screw 210, so that when the worm screw drives the worm wheel to rotate. This allows the worm wheel to drive the worm gear mechanism 220 to move along the extension direction of the screw 210, to further adjust the position of the support structure 10 in the vertical direction.

Optionally, the lifting mechanism also includes a handwheel 250, which is connected with one end of the worm screw, which one end is spaced apart from the first drive motor 230. The worm wheel can also be rotated by rotating the handwheel 250. Therefore, when the height of one side of the support structure 10 needs to be adjusted, the handwheel 250 on the lifting mechanism below the side can be turned. In this way, the position accuracy of the printing component 50 on the support structure 10 can be further improved so as to improve the printing quality, creating pairs of adjusting mechanisms plus lifting mechanisms.

As an alternative, the adjusting mechanism 30 includes a plurality of adjusting mechanisms, and a plurality of adjusting mechanisms and a plurality of lifting mechanisms are arranged in one-to-one correspondence.

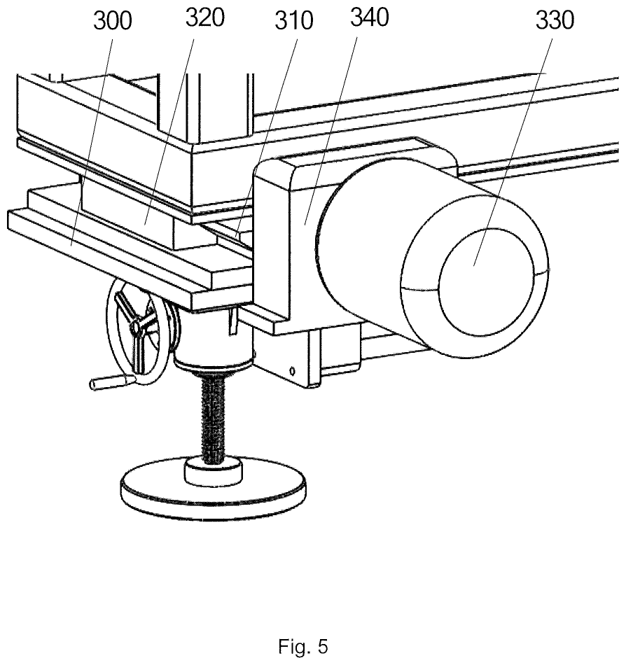

FIG. 4 is a schematic side view of a lifting mechanism 20 and an adjusting mechanism 30 of the 3D printer according to an embodiment of the present application. FIG. 5 is a schematic perspective view of an adjusting mechanism of the 3D printer according to an embodiment of the present application. As shown in FIGS. 4 and 5, as an alternative, the adjusting mechanism 30 includes a second drive motor 330, a second mounting plate 340, a connecting plate 300, a slot seat 310 and a moving plate 320.

The connecting plate 300 is arranged at the end that is close to the lifting mechanism 30, the slot seat 310 is fixed at the end of the connecting plate 300 that is spaced apart from the lifting mechanism, the moving plate 320 is installed on the slot seat 310 and can slide relative to the slot seat 310, and the moving plate 320 is provided with a screw nut and a passage for the screw to pass through, and the output end of the second drive motor 330 is connected with the screw to drive the moving plate 320 along the extension direction of the slot seat 310.

The second mounting plate 340 is fixed to the connecting plate 300 for mounting the second drive motor 330, and the end of the moving plate 320 that is spaced apart from the slot seat 310 is connected with the support structure 10.

In this embodiment, when the support structure 10 is moved in the horizontal direction, the second drive motor 330 rotates the screw rod. Because the screw rod is connected with the screw nut in the moving plate, the rotation of the screw rod can drive the moving plate 320 to move relative to the groove seat 310, and the end of the moving plate 320 that is spaced apart from the groove seat 310 is connected with the support structure 10, thereby driving the support structure 10 to move in the horizontal direction.

It should be noted that the way to move the support structure 10 in the horizontal direction is not limited to the above-mentioned way, and other ways are not listed here.

As an alternative, the support structure 10 includes a horizontal bracket 110 and a vertical bracket 100, wherein the adjusting mechanism 30 and the lifting mechanism 20 are successively installed below the horizontal bracket 110, and the moving mechanism 40 is installed on the vertical bracket 100. The vertical bracket 100 is vertically arranged on the horizontal bracket 110.

It should be noted that the horizontal bracket 110 is U-shaped to ensure there is enough space for the product printed by the printing component 50.

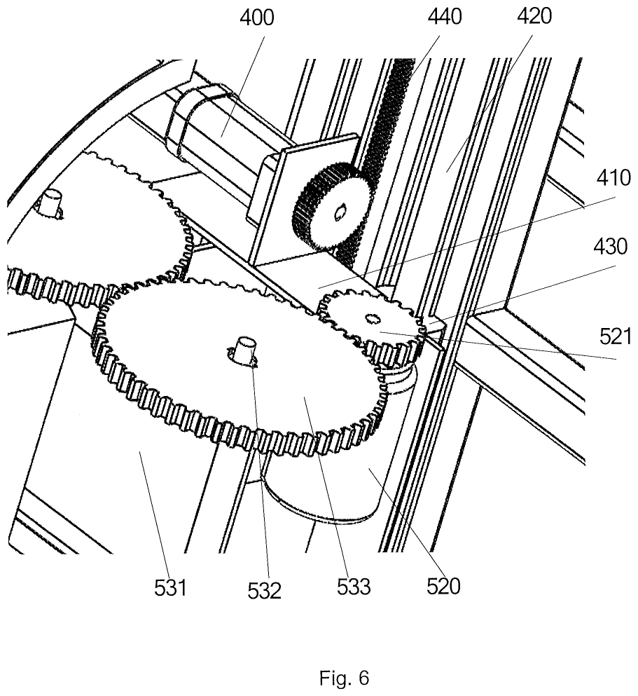

FIG. 6 is a schematic perspective view of a moving mechanism and a printing component of the 3D printer according to an embodiment of the present application. As shown in FIG. 6, as an alternative, the moving mechanism 40 includes a third drive motor 400, a connecting structure 410, a guide rail 420, a slider 430 and a rack 440. The rack 440 and the guide rail 420 are both arranged on the vertical support 100, and the guide rail 420 is arranged in parallel with the rack 440. The slider 430 and the third drive motor 400 are both installed on the connecting structure 410, and the slider 430 meshes with the guide rail. The output shaft of the third drive motor 400 is provided with a gear for meshing with the rack 440.

In this embodiment, the connecting structure 410 is slidably connected with the guide rail 420 arranged on the vertical bracket 100 through the slider 430 arranged on the connecting structure 410, the third drive motor 400 is arranged on the connecting structure 410, and the gear arranged on the output shaft of the third drive motor 400 meshes with the rack 440 installed on the vertical bracket 100, and the rack 440 is arranged in parallel with the guide rail 420, so that when the third drive motor 400 is powered, driven by the third drive motor 400, the connecting structure 410 moves along the extension direction of the guide rail 420 and the rack 440, and the extension direction of the guide rail 420 and the rack 440 is vertical.

It should be noted that in order to ensure the stability of the vertical movement of the connecting structure 410, two guide rails 420 are provided on both sides of the rack 440.

As an alternative, the support structure 50 includes a first bell-mouth mold 500, a second bell-mouth mold 510, a fourth drive motor 520, a first rotating member 530 and a second rotating member 540. The first bell-mouth mold is installed on the first rotating member 530, the second bell-mouth mold is installed on the second rotating member 540, the first rotating member 530, the second rotating member 540 and the fourth drive motor 520 are all installed on the connecting structure 410, and the fourth drive motor 520 is used to drive the first rotating member 530 and the second rotating member 540 to rotate to control the opening and closing of the first bell-mouth mold 500 and the second bell-mouth mold 510.

In this embodiment, the fourth drive motor 520 controls the opening and closing of the first bell-mouth mold 500 and the second bell-mouth mold 510 through the first rotating member 530 and the second rotating member 540. During the printing process, the first bell-mouth mold 500 and the second bell-mouth mold 510 are in a closed state. After the printing is completed, the fourth drive motor 520 works to control the opening of the first bell-mouth mold 500 and the second bell-mouth mold 510 to facilitate moving printing of the object.

As an alternative, the first rotating member 530 includes a first rotating plate 531, a first rotating shaft 532 and a first gear wheel 533, wherein the first rotating plate 531 is rotatably mounted on the connecting structure 410 through the first rotating shaft 532, and the first gear wheel 533 is mounted on the first rotating shaft 532. The second rotating member 540 includes a second rotating plate 541, a second rotating shaft 542 and a second gear wheel 543, wherein the second rotating plate 541 is rotatably installed on the connecting structure 410 through the second rotating shaft 542, and the second gear wheel 543 is installed on the second rotating shaft 542. The first gear wheel 533 is in transmission connection with the second gear wheel, and the first gear wheel 533 is connected with the pinion 521 installed on the fourth driving motor 520.

Obviously, those skilled on the art can make various modifications and variations to the embodiments of the present invention without departing from the spirit and scope of the present invention. If these modifications and variations of the present invention fall within the scope of the claims of the present invention and its equivalent technology, the present invention is also intended to include these modifications and variations.

### LIST OF REFERENCE NUMBERS

10 support structure
100 vertical support
110 horizontal bracket
20 lifting mechanism
200 base
210 screw
220 worm gear mechanism
230 first drive motor
240 first mounting plate
250 handwheel
30 adjusting mechanism
300 connecting plate
310 slot seat
320 moving plate
330 second drive motor
340 second mounting plate
40 moving mechanism
400 third drive motor
410 connecting structure
420 guide rail
430 slider
440 rack
50 print component
500 first bell-mouth mold
510 second bell-mouth mold
520 fourth drive motor
521 pinion
530 first rotating member
531 first rotating plate
532 first rotating shaft
533 first gear wheel
540 second rotating member
541 second rotating plate
542 second rotating shaft
543 second gear wheel

What is claimed is:

1. A 3D printer, comprising:
a support structure, a lifting mechanism, an adjusting mechanism, a moving mechanism and a printing component; wherein
the adjusting mechanism and the lifting mechanism are arranged below the support structure;
the lifting mechanism is adapted to move the support structure up and down in the vertical direction;
the adjusting mechanism is adapted to move the support structure in the horizontal direction;
the printing component is arranged on the moving mechanism; and
the moving mechanism is arranged on the support structure in such fashion that it is movable up and down in the vertical direction.

2. The 3D printer according to claim 1, comprising a plurality of lifting mechanisms.

3. The 3D printer according to claim 2, wherein
the lifting mechanism comprises a base, a screw, a worm gear mechanism, a first drive motor and a first mounting plate for mounting the first drive motor;
the screw is fixedly arranged with a first end thereof on the base and a second end thereof to the adjusting mechanism;
the first mounting plate is installed on the worm gear mechanism;
the worm wheel in the worm gear mechanism is installed on the screw; and
the worm screw is connected with an output shaft of the first drive motor.

4. The 3D printer according to claim 3, wherein the lifting mechanism further comprises a handwheel, which is connected to an end of the worm screw that is spaced apart from the first drive motor.

5. The 3D printer according to claim 2, comprising a plurality of adjusting mechanisms, and the plurality of the adjusting mechanisms are arranged in a paired fashion paired with respective ones of the lifting mechanisms.

6. The 3D printer according to claim 5, wherein the adjusting mechanism comprises:
a second drive motor, a second mounting plate, a connecting plate, a slot seat and a moving plate;
the connecting plate is arranged at an end that is close to the lifting mechanism;
the slot seat is fixed at an end of the connecting plate that is spaced apart from the lifting mechanism;
the moving plate is installed on the slot seat such that it is slidable relative to the slot seat;
the moving plate is internally provided with a screw nut and a passage for the screw to pass through;
an output end of the second drive motor is connected with the screw to drive the moving plate to slide along the extension direction of the slot seat;
the second mounting plate is fixed on the connecting plate for mounting the second drive motor; and
an end of the moving plate that is spaced apart from the slot seat is connected with the support structure.

7. The 3D printer according to claim 1, wherein
the support structure comprises a horizontal bracket and a vertical bracket;
the adjusting mechanism and the lifting mechanism are installed below the horizontal bracket;
the moving mechanism is installed on the vertical bracket; and
the vertical bracket is arranged on the horizontal bracket, extending from said horizontal bracket in a vertical direction.

8. The 3D printer according to claim 7, wherein
the moving mechanism comprises a third drive motor, a connecting structure, a guide rail, a slider and a rack;
the rack and the guide rail are both arranged on the vertical bracket;
the guide rail extends in parallel with the rack;
the slider and the third drive motor are both installed on the connecting structure;
the slider meshes with the guide rail; and
the output shaft of the third drive motor is provided with a gear for meshing with the rack.

9. The 3D printer according to claim 8, wherein
the printing component comprises a first bell-mouth mold, a second bell-mouth mold, a fourth drive motor, a first rotating member and a second rotating member;
the first bell-mouth mold is installed on the first rotating member;
the second bell-mouth mold is installed on the second rotating member;
the first rotating member, the second rotating member and the fourth drive motor are all installed on the connecting structure; and
the fourth drive motor is used to drive the first rotating member and the second rotating member to rotate to control the opening and closing of the first bell-mouth mold and the second bell-mouth mold.

10. The 3D printer according to claim 9, wherein
the first rotating member comprises a first rotating plate, a first rotating shaft and a first gear wheel;
the first rotating plate is rotatably mounted on the connecting structure through the first rotating shaft;
the first gear wheel is mounted on the first rotating shaft;
the second rotating member comprises a second rotating plate, a second rotating shaft and a second gear wheel;
the second rotating plate is rotatably installed on the connecting structure through the second rotating shaft;
the second gear wheel is installed on the second rotating shaft;
the first gear wheel is in a driving connection with the second gear wheel; and
the first gear wheel is connected with the pinion installed on the fourth drive motor.
